(19) United States
(12) Patent Application Publication
(10) Pub. No.: US 2005/0071368 A1
(43) Pub. Date: Mar. 31, 2005

(54) Apparatus and method for displaying multimedia data combined with text data and recording medium containing a program for performing the same method

(75) Inventors: Du-Il Kim, Suwon-si (KR); Young-Yoon Kim, Seoul (KR); Vladimir Portnykh, Surrey (GB)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/949,474

(22) Filed: Sep. 27, 2004

Related U.S. Application Data
(60) Provisional application No. 60/505,717, filed on Sep. 25, 2003.

(30) Foreign Application Priority Data
Nov. 12, 2003 (KR) 10-2003-0079853

(51) Int. Cl. G06F 7/00

(52) U.S. Cl. 707/102

(57) ABSTRACT

An apparatus and method for displaying multimedia data combined with text data and a recording medium on which the same method is recorded. In the apparatus for displaying multimedia data combined with text data and described according to a MusicPhotoVideo (MPV) format, it is checked whether an asset selected by a user is comprised of single audio data and one or more text data. Information needed for displaying the audio data and the text data is extracted, the audio data is extracted for playback using the extracted information, and the one or more text data are extracted from the extracted information and sequentially displayed using a predetermined displaying method during playback of the audio data.

This application claims the priority of Korean Patent Application No. 10-2003-79853 filed on Nov. 12, 2003 in the Korean Intellectual Property Office, and U.S. Provisional Patent Application No. 60/505,717 filed on Sep. 25, 2003 in the United States Patent and Trademark Office, the disclosures of which are incorporated herein in its entirety by reference.

### BACKGROUND OF THE INVENTION

1. Field of the Invention

The present invention relates to an apparatus and method for displaying multimedia data combined with text data and a recording medium on which the same method is recorded, and more particularly, to management of content such as audio data, photo data, or video data combined with one or more text data in a MultiPhotoVideo or MusicPhotoVideo (MPV) format in order to present the content to users.

2. Description of the Related Art

MPV is an industrial standard specification dedicated to multimedia titles, published by the Optical Storage Technology Association (hereinafter referred to as “OSTA”), an international trade association established by optical storage makers in 2002. Namely, MPV is a standard specification to provide a variety of music, photo and video data more conveniently or to manage and process the multimedia data. The definition of MPV and other standard specifications are available for use through the official web site (www.osta.org) of the OSTA.

Recently, media data comprising digital pictures, video, digital audio, text and the like are processed and played by means of personal computers (PC). Devices for playing the media content, e.g., digital cameras, digital camcorders, digital audio players (namely, digital audio data playing devices such as Moving Picture Experts Group Layer-3 Audio (MP3), Window Media Audio (WMA) and so on) have been in frequent use, and various kinds of media data have been produced in large quantities accordingly.

However, personal computers have mainly been used to manage multimedia data produced in large quantities; in this regard file-based user experience has been requested. In addition, when multimedia data is produced on a specified product, attributes of the data, data playing sequences, and data playing methods are produced depending upon multimedia data. If they are accessed by the personal computers, the attributes are lost and only the source data is transferred. In other words, there is a very weak inter-operability relative to data and attributes of the data between household electric goods, personal computers and digital content playing devices.

An example of the weak inter-operability will be described. A picture is captured by use of a digital camera, and data such as the sequence for attributes of a slide show determined by use of a slideshow function to identify the captured picture on the digital camera, time intervals between pictures, relations between pictures whose attributes determined by use of a panorama function, and attributes determined by use of a consecutive photoing function are stored along with actual picture data as the source data. At this time, if the digital camera transfers pictures to a television set by use of an AV cable, a user can see multimedia data whose respective attributes are represented. However, if the digital camera is accessed to a personal computer by use of a universal serial bus (USB), only the source data is transferred to the computer and their respective attributes are lost.

As described above, it is shown that the inter-operability of the personal computer for metadata such as attributes of data stored in the digital cameral is very weak or there is no inter-operability of the personal computer to the digital camera.

In order to strengthen the inter-operability, relative to data, between digital devices, the standardization for MPV has been in progress.

MPV specification defines Manifest, Metadata and Practice to process and play sets of multimedia data such as digital pictures, video, audio, etc. stored in storage medium (or device) comprising an optical disk, a memory card, and a computer hard disk, or exchanged by the Internet Protocol (IP).

The standardization for MPV is currently being advanced by the OSTA (Optical Storage Technology Association) and I3A (International Imaging Industry Association). The MPV takes an open specification and mainly proposes to make it easy to process, exchange and play sets of digital pictures, video, digital audio and text and so on.

MPV is roughly classified into MPV Core-Spec (0.90WD) and Profile.

The core is composed of three basic factors such as Collection, Metadata and Identification.

The Collection has Manifest as a Root member, and it comprises Metadata, Album, MarkedAsset and AssetList, etc. The Asset refers to multimedia data described according to the MPV format, being classified into two kinds: Simple media asset (e.g., digital pictures, digital audio, text, etc.) and Composite media asset (e.g., digital picture combined with digital audio (StillWithAudio), digital pictures photoed consecutively (StillMultishotSequence), and panorama digital pictures (StillPanoramaSequence), etc.). FIG. 1 illustrates examples of StillWithAudio, StillMultishotSequence, and StillPanoramaSequence.

Metadata adopts the format of extensible markup language (XML) and has five kinds of identifiers for identification.
1. LastURL is path name and file name of a concerned asset (Path to the object),
2. InstanceID is an ID unique to each asset (unique per object: e.g., Exif 2.2),
3. DocumentID is identical to both source data and modified data,
4. ContentID is created whenever a concerned asset is used for a specified purpose, and
5. id is a local variable within metadata.

There are seven profiles: Basic profile, Presentation profile, Capture/Edit profile, Archive profile, Internet profile, Printing profile and Container profile.

MPV supports management of various file associations by use of XML metadata so as to allow various multimedia data recorded on storage media to be played. Especially, MPV supports JPEG (Joint Photographic Experts Group), MP3, WMA (Windows Media Audio), WMV (Windows Media Video), MPEG-1 (Moving Picture Experts Group-1), MPEG-2, MPEG-4, and digital camera formats such as AVI (Audio Video Interleaved) and Quick Time MJPEG (Motion Joint Photographic Experts Group) video. MPV specification-adopted discs are compatible with ISO9660 level 1, Joliet, and also multi-session CD (Compact Disc), DVD (Digital Versatile Disc), memory cards, hard discs and Internet, thereby allowing users to manage and process various multimedia data.

However, new formats of various multimedia data not defined in the MPV format specification, namely new formats of assets are in need and addition of a function to provide the multimedia data is desired.

### SUMMARY OF THE INVENTION

The present invention provides a new type of multimedia data in addition to the existing diverse collections of multimedia data provided in the current MusicPhotoVideo (MPV) format and a method for providing the new type of multimedia data to a user, thus enabling more diverse use of collections of multimedia data.

Consistent with an aspect of the present invention, there is provided an apparatus for displaying multimedia data described according to the MPV format, wherein it is checked whether an asset selected by a user is comprised of single audio data and one or more text data, information needed for displaying the audio data and the text data is extracted, the single audio data is extracted for playback using the extracted information, and the one or more text data are extracted from the extracted information and sequentially displayed using a predetermined displaying method during playback of the single audio data.

In an exemplary embodiment, the asset includes information on a position at which the text data is displayed and a time when the text data is displayed. Also, the displaying method may comprise displaying each text data based on display time information needed for designating the time when the text data is displayed while playing back the audio data.

Consistent with another aspect of the present invention, there is provided an apparatus for displaying multimedia data combined with text data and described according to a MusicPhotoVideo (MPV) format, wherein it is checked whether an asset selected by a user is comprised of single video data and one or more text data, information needed for displaying the video data and the text data is extracted, the video-data is extracted for playback using the extracted information, and the one or more text data are extracted from the extracted information and sequentially displayed using a predetermined displaying method during playback of the video data. In this case, the asset includes information on a position at which the text data is preferably displayed and a time when the text data is displayed. Also, the displaying method may comprise displaying each text data based on display time information needed for designating the time when the text data is displayed while playing back the video data.

Consistent with yet another aspect of the present invention, there is provided an apparatus for displaying multimedia data combined with text data and described according to a MusicPhotoVideo (MPV) format, wherein it is checked whether an asset selected by a user is comprised of single image data and one or more text data, information needed for displaying the image data and the text data is extracted, the image data is extracted for display using the extracted information, and the one or more text data are extracted from the extracted information and sequentially displayed using a predetermined displaying method during the display of the image data.

In an exemplary embodiment, the asset includes information on a position at which the text data is displayed and a time when the text data is displayed. Also, the displaying method may comprise displaying each text data based on display time information needed for designating the time when the text data is displayed while playing back the image data.

Consistent with still another aspect of the present invention, there is provided a method for displaying multimedia data combined with text data and described according to a MusicPhotoVideo (MPV) format, the method comprising checking whether an asset selected by a user is comprised of single audio data and one or more text data, extracting information needed for displaying the audio data and the text data; extracting the audio data for playback using the extracted information, and extracting the one or more text data from the extracted information and sequentially displaying the text data using a predetermined displaying method during playback of the audio data.

Here, the asset preferably, but not necessarily, includes information on a position at which the text data is displayed and a time when the text data is displayed, and the displaying method may comprise displaying each text data based on display time information needed for designating the time when the text data is displayed while playing back the audio data. Also, the display time information preferably, but not necessarily, includes a time when displaying the text data starts, and a display duration in which the text data is played back.

Consistent with a further aspect of the present invention, there is provided a method for displaying multimedia data combined with text data and described according to a MusicPhotoVideo (MPV) format, the method comprising checking whether an asset selected by a user is comprised of single video data and one or more text data, extracting information needed for displaying the video data and the text data; extracting the video data for playback using the extracted information, and extracting the one or more text data from the extracted information and sequentially displaying the text data using a predetermined displaying method during playback of the video data.

In an exemplary embodiment, the displaying method comprises displaying each text data based on display time information needed for designating the time when the text data is displayed while playing back the video data. The display time information includes a time when displaying the text data starts, and a display duration in which the text data is displayed. Also, the asset includes information on a position at which the text data is displayed and a time when the text data is displayed.

Consistent with yet another aspect of the present invention, there is provided a method for displaying multimedia data combined with text data and described according to a MusicPhotoVideo (MPV) format, the method comprising checking whether an asset selected by a user is comprised of single image data and one or more text data, extracting information needed for displaying the image data and the text data; extracting and displaying the image data using the extracted information, and extracting the one or more text data from the extracted information and sequentially displaying the text data using a predetermined displaying method during display of the image data.

In an exemplary embodiment, the displaying method comprises displaying each text data based on display time information needed for designating the time when the text data is displayed while displaying the image data. In this case, the display time information includes a time when displaying the text data starts, and a display duration in which the text data is displayed. Also, the asset preferably, but not necessarily, includes information on a position at which the text data is displayed and a time when the text data is displayed.

Consistent with still another aspect of the present invention, there is provided a recording medium on which a program for displaying multimedia data described according to a MusicPhotoVideo (MPV) format is recorded, wherein the program checks whether an asset selected by a user is comprised of single audio data and one or more text data, extracts information needed for displaying the audio data and the text data, extracts the audio data for playback using the extracted information, and extracts the one or more text data from the extracted information in order to sequentially display the text data using a predetermined displaying method during playback of the audio data.

Consistent with a further aspect of the present invention, there is provided a recording medium on which a program for displaying multimedia data described according to a MusicPhotoVideo (MPV) format is recorded, wherein the program checks whether an asset selected by a user is comprised of single video data and one or more text data, extracts information needed for displaying the video data and the text data, extracts the video data for playback using the extracted information, and extracts the one or more text data from the extracted information in order to sequentially display the text data using a predetermined displaying method during playback of the video data.

Consistent with yet another aspect of the present invention, there is provided a recording medium on which a program for displaying multimedia data described according to a MusicPhotoVideo (MPV) format is recorded, wherein the program checks whether an asset selected by a user is comprised of single image data and one or more text data, extracts information needed for displaying the image data and the text data, extracts the image data for display using the extracted information, and extracts the one or more text data from the extracted information in order to sequentially display the text data using a predetermined displaying method during display of the image data.

### BRIEF DESCRIPTION OF THE DRAWINGS

The above and other features and advantages of the present invention will become more apparent by describing in detail exemplary embodiments thereof with reference to the attached drawings in which:

FIG. 1 is an exemplary diagram of the type of assets specified in a MusicPhotoVideo (MPV) specification;

FIG. 2 is an exemplary diagram briefly defining a <TextContent> element consistent with an embodiment of the present invention;

FIG. 3 is an exemplary diagram briefly defining a <TextBody> element consistent with an embodiment of the present invention;

FIG. 4A is an exemplary diagram briefly defining a <TextLocation> element consistent with an embodiment of the present invention, and FIG. 4B is an exemplary diagram illustrating the relationship among position coordinates of children elements forming the <TextLocation> element consistent with an embodiment of the present invention;

FIG. 5 is an exemplary diagram briefly defining an <AudioWithText> element consistent with an embodiment of the present invention;

FIG. 6 is an exemplary diagram showing a type definition for an <AudioWithTextType> element consistent with an embodiment of the present invention;

FIG. 7 is an exemplary diagram briefly defining a <PhotoWithText> element consistent with an embodiment of the present invention;

FIG. 8 is an exemplary diagram showing a type definition for a <PhotoWithTextType> element type consistent with an embodiment of the present invention;

FIG. 9 is an exemplary diagram briefly defining a <VideoWithText> element consistent with an embodiment of the present invention;

FIG. 10 defines the structure of a <TextContentType> illustrating a type definition for a <VideoWithText> element type consistent with an embodiment of the present invention;

FIG. 11 is an exemplary diagram briefly defining an <AudioWithTextRef> element consistent with an embodiment of the present invention;

FIG. 12 is an exemplary diagram briefly defining a <PhotoWithTextRef> element consistent with an embodiment of the present invention;

FIG. 13 is an exemplary diagram briefly defining a <VideoWithTextRef> element consistent with an embodiment of the present invention;

FIGS. 14A and 14B are a flowchart illustrating a method for displaying a ‘VideoWithText’ asset consistent with an embodiment of the present invention; and

FIGS. 15A-15C are a flowchart illustrating a method for displaying a ‘PhotoWithText’ asset consistent with an embodiment of the present invention.

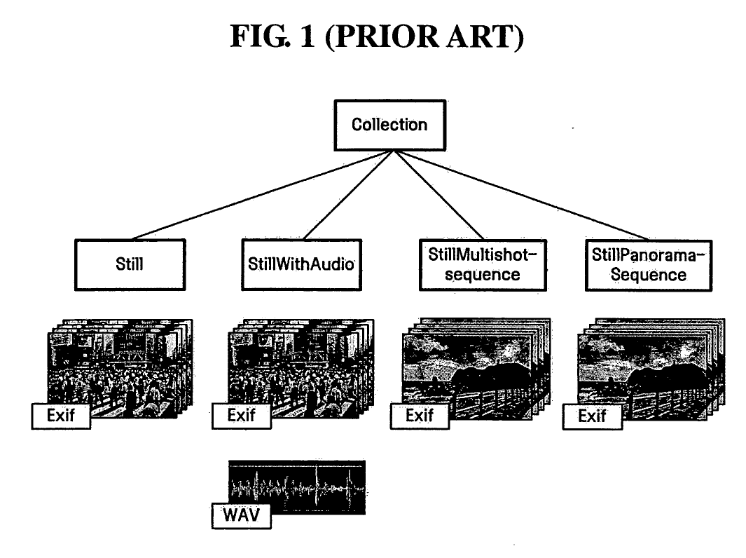

### DETAILED DESCRIPTION OF THE INVENTION

The present invention uses an Extensible Markup Language (XML) to provide multimedia data compliant with the MusicPhotoVideo (MPV) format. Hereinafter, the present invention will now be described according to an XML schema.

The present invention provides more diverse collections of multimedia data by adding ‘AudioWithText’, ‘PhotoWithText’, and ‘VideoWithText’ assets not currently proposed by the Optical Storage Technology Association (OSTA) to the existing data. Definitions and examples of using the three new assets will now be provided. Hereinafter, ‘smpv’ and ‘mpv’ are XML namespaces for elements proposed in the present invention and the OSTA, respectively.

1. ‘AudioWithText’ Asset

‘AudioWithText’ is an asset that combines a single audio asset with one or more caption data. If the asset is described using XML, it can be referred to as an <AudioWithText> element. The audio asset and text data are treated as an element in a file described using XML. In order to define the structure of the <AudioWithText> element, the structure of the text data combined with the audio asset must first be examined. The present invention defines a <TextContent> element as an element representing the structure of the text data.

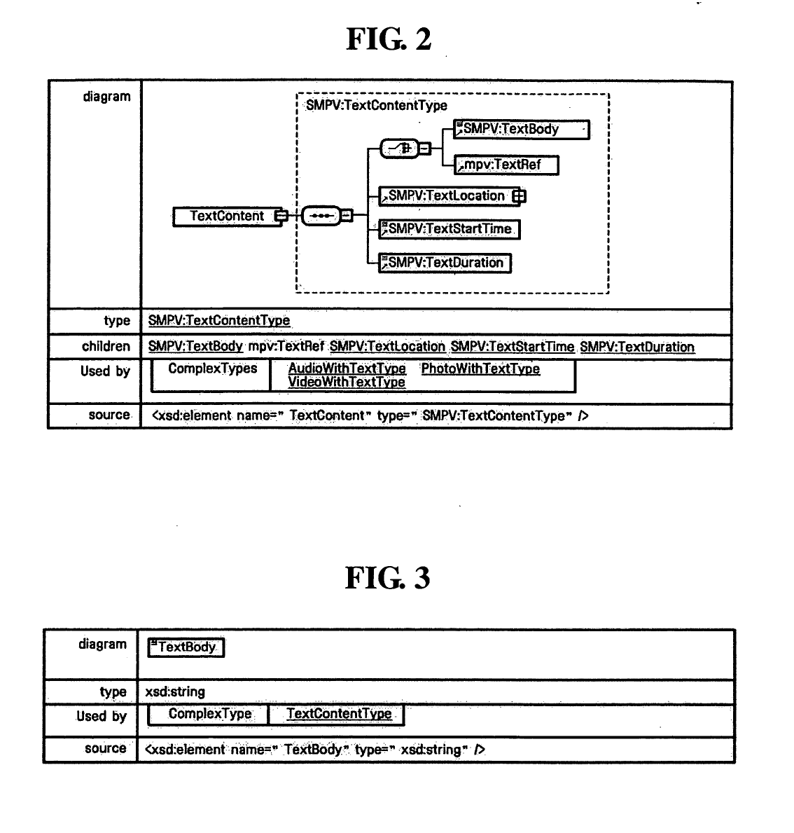

FIG. 2 schematically defines the structure of a <TextContent> element. Referring to the diagram of the <TextContent> element in FIG. 2, the <TextContent> element comprises multiple children elements using ‘mpv’ and ‘smpv’ as namespaces.

Here, since the elements using ‘mpv as a namespace have been described on OSTA's website at www.osta.org, an explanation thereof will not be given. Thus, the elements using ‘smpv’ as a name space will now be described.

(1) <TextBody> Element

A <TextBody> element represents text data well-formatted according to Hyper Text Markup Language (HTML) standards. The <TextBody> element can specify HTML text characteristics such as Cascading Style Sheets (CSS) properties that define the font or color of the text. While the <TextBody> element is mainly used to display a small amount of text data that are directly defined in a MPV file, a <TextRef> element is defined in a MPV core specification. Unlike the <TextBody> element where the text data are directly described in the MPV file, the <TextRef> element makes reference to a separate file containing the text data. In this case, the separate file may be in MPV or other formats. When the <TextRef> element is not defined as an attribute associated with the <TextContent> element, the <TextBody> element must be described as briefly shown in FIG. 3.

(2) <TextLocation> Element

A <TextLocation> element defines the position of a subtitle or caption on a screen. In the absence of the <TextLocation> element, a default instruction may be used. HTML and Synchronized Multimedia Integration Language (SMIL) formats offer a method of defining text properties. However, if the <TextLocation> element is used, the characteristics defined by the <TextLocation> element override others.

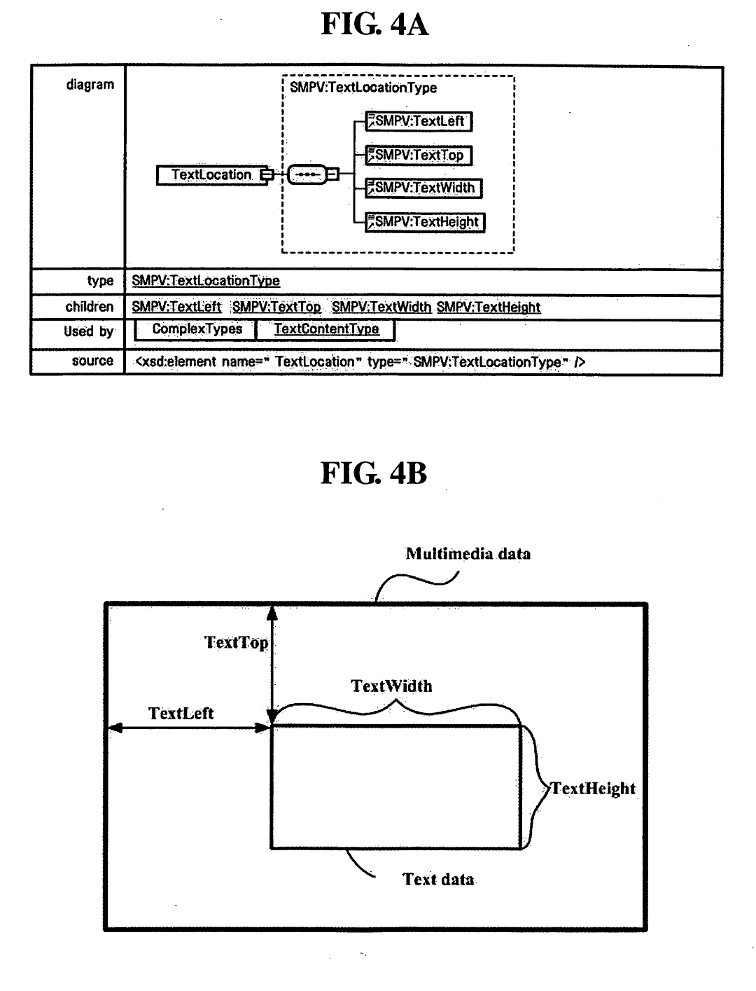

The <TextLocation> element may have children elements representing position coordinates at which a text is displayed. The children elements include <TextLeft>, <TextTop>, <TextWidth>, and <TextHeight>. While FIG. 4A briefly defines the <TextLocation> element, FIG. 4B illustrates the relationship among position coordinates of the children elements forming the <TextLocation> element.

(3) <TextStartTime> Element

A <TextStartTime> element represents the time when the text data starts to be displayed and is defined in the <TextBody> or <TextRef> element. For the <TextBody> element, the <TextStartTime> element value must be defined. For the <TextRef> element, the <TextStartTime> element may optionally be defined for more finely tuning the start time.

(4) <TextDuration> Element

A <TextDuration> element denotes the duration that the text data is displayed. In the case of a caption defined in the <TextBody> element, the <TextDuration> element may be used together with a <TextStart> element.

(5) <AudioWithText> Element

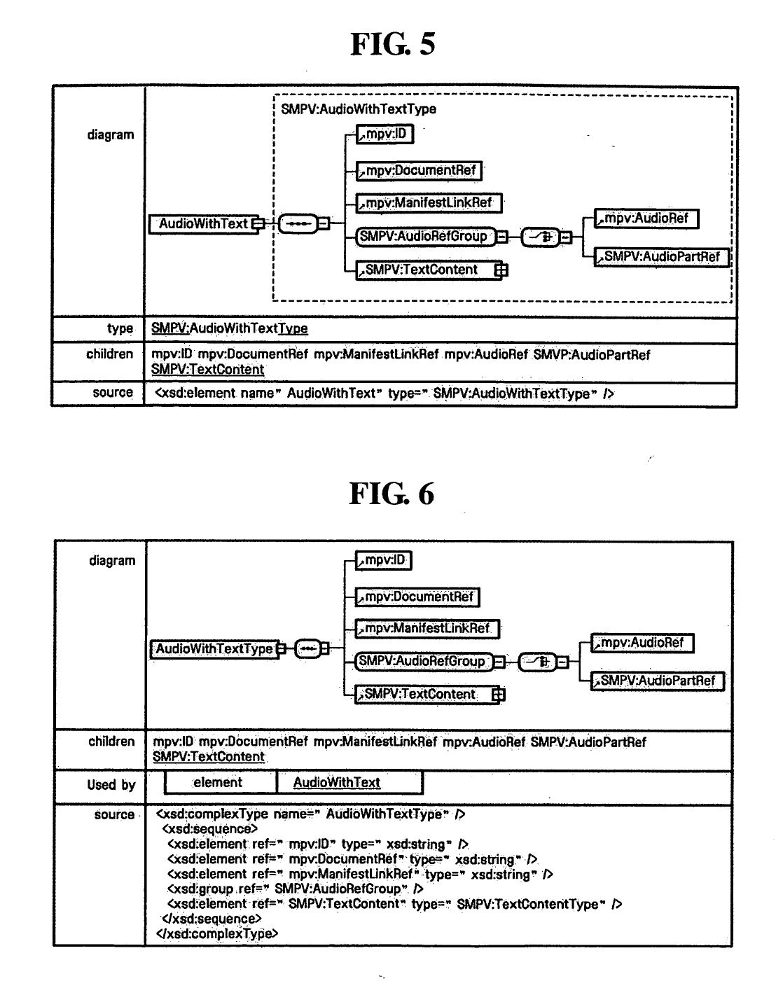

FIG. 5 schematically defines the structure of an <AudioWithText> element. Referring to the diagram of the <AudioWithText> element in FIG. 5, the <AudioWithText> element is comprised of multiple children elements using ‘mpv’ and ‘smpv’ as namespaces.

Here, since the elements using ‘mpv’ as a namespace have been described on the OSTA's website at www.osta.org, an explanation thereof will not be given. A <TextContent> element using ‘smpv’ as a namespace defines text data being displayed. An ‘AudioRefGroup’ element defined to designate audio data comprises an <AudioRef> element provided in the MPV core specification and an <AudioPartRef> element defined according to an embodiment of the present invention that makes reference to an <AudioPart> element specifying a part of the audio data. FIG. 6 illustrates a type definition for an <AudioWithTextType> element.

2. ‘PhotoWithText’ Asset

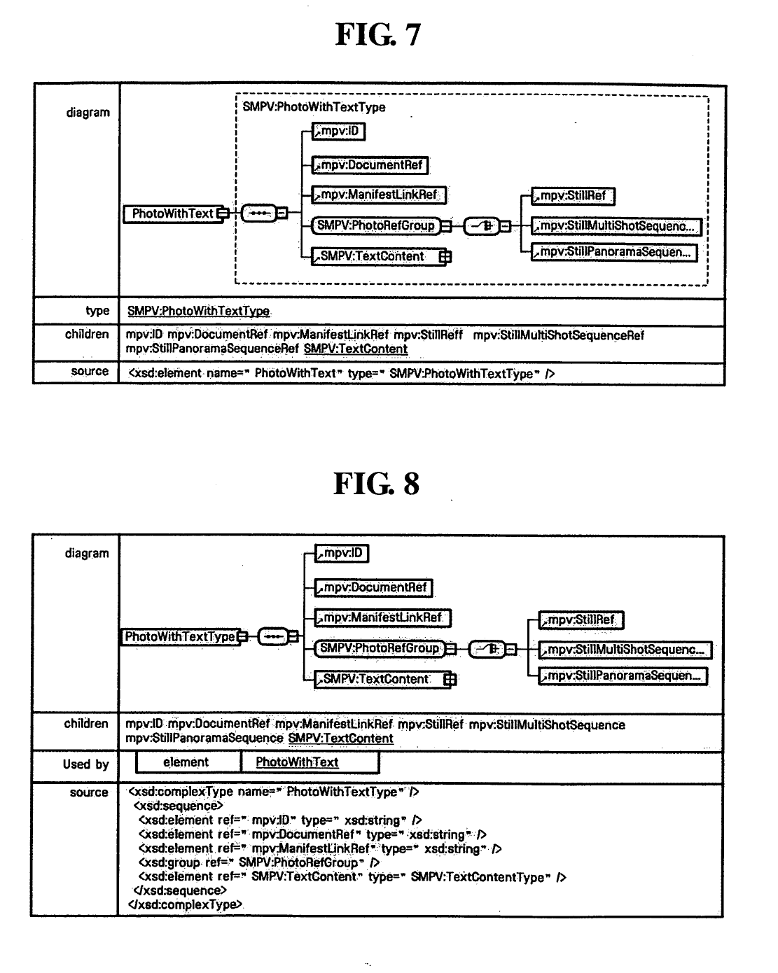

FIG. 7 schematically defines the structure of a <PhotoWithText> element. ‘PhotoWithText’ is an asset that combines single image data with one or more text data. The asset described using XML can be referred to as the <PhotoWithText> element. To display the text data in the image data, position information on the text data is defined in the <PhotoWithText> element. Two or more text data may be displayed in single image data. FIG. 8 illustrates a type definition for a <PhotoWithTextType> element.

3. ‘VideoWithText’ Asset

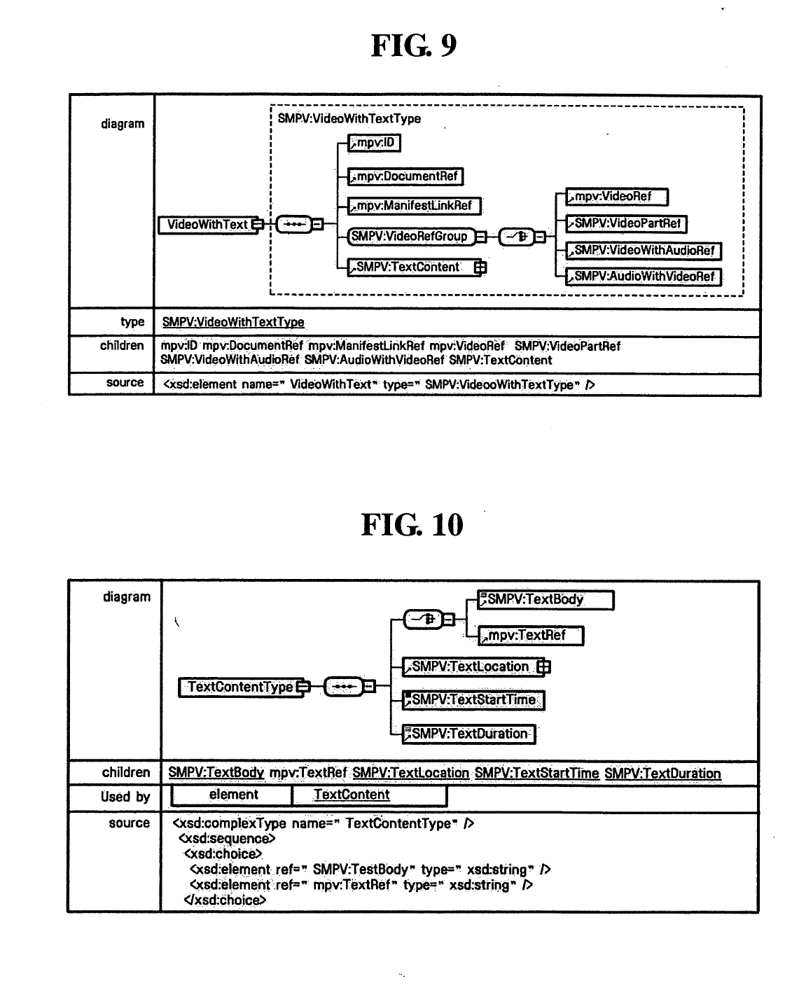

FIG. 9 schematically defines the structure of a <VideoWithText> element. ‘VideoWithText’ is an asset that combines single video data with one or more text data. The asset described using XML can be referred to as the <VideoWithText> element. The ‘VideoWithText’ asset may be used for displaying a subtitle of a movie or other additional information on a screen while the movie is playing. FIG. 10 defines the structure of a <TextContentType> illustrating a type definition for a <VideoWithTextType> element.

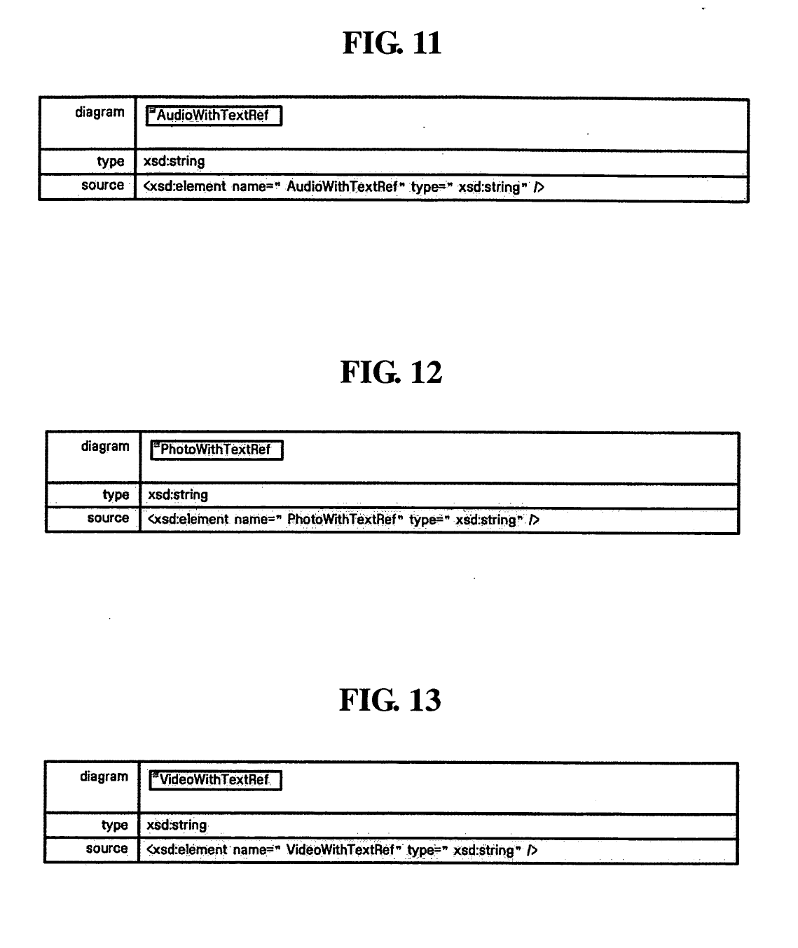

4. Elements for Referencing

<AudioWithTextRef>, <PhotoWithTextRef>, and <VideoWithText Ref> elements are similarly structured to make references to ‘AudioWithText’, ‘PhotoWithText’, and ‘VideoWithText’ assets, respectively. FIGS. 11-13 illustrate the structures of the elements for referencing.

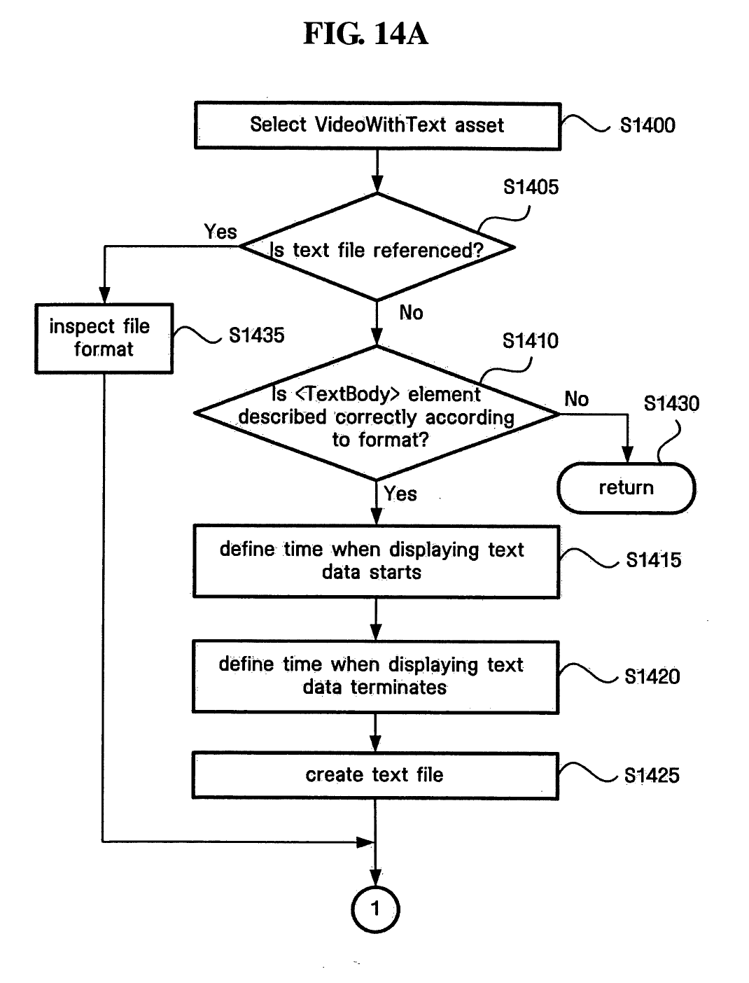

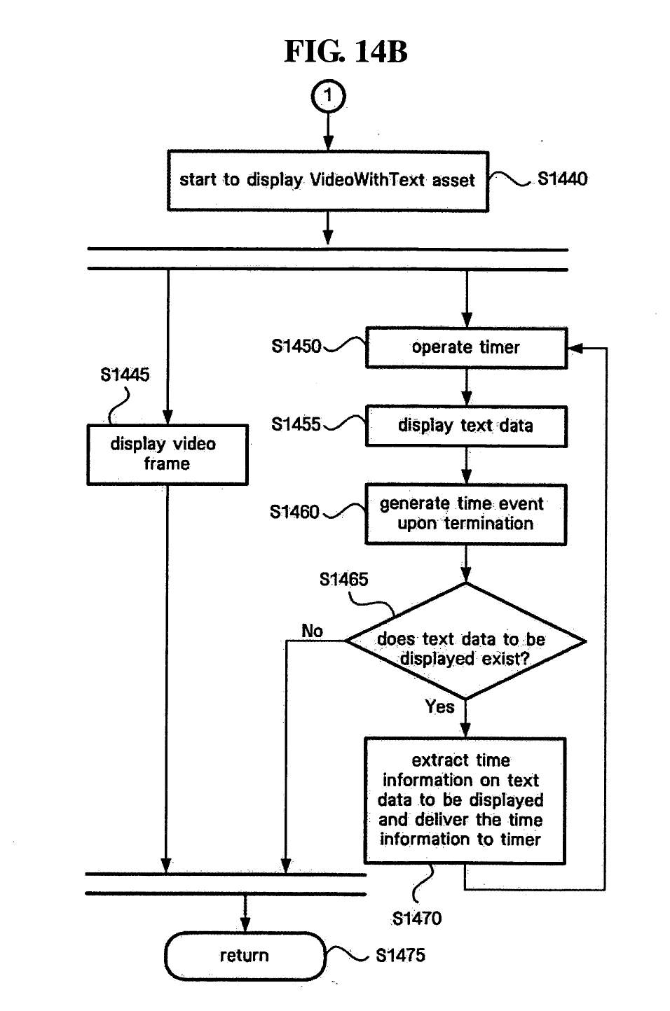

FIGS. 14A and 14B are a flowchart illustrating a method for displaying a ‘VideoWithText’ asset consistent with an embodiment of the present invention.

When a user selects the ‘VideoWithText’ asset using software for MVP file playback in step S1400, the software checks whether a text file is referenced in order to extract text data contained in the ‘VideoWithText’ asset in step S1405.

In step S1435, if the text file is referenced, i.e., a <TextRef> element is present in the asset, the software inspects the format of the text file referenced by the <TextRef> element. If the text file is well formatted, the ‘VideoWithText’ asset starts to be displayed in step S1440. If not, an error message is generated and then delivered to the user, followed by return of a return value or termination of the appropriate program (not shown).

If the text data is directly described in the MPV file in step S1405, that is, a <TextBody> element is contained in the asset, it is checked whether the <TextBody> element is described correctly according to the appropriate format in step S1410. If the <TextBody> element is described correctly according to the format, the time when displaying the text data starts and terminates is defined in steps S1415 and S1420, respectively, and a separate text file is created in step S1425. Conversely, if the <TextBody> element is not described correctly according to the format, an error message is generated and delivered to the user, followed by a return of a return value or termination of the appropriate program in step S1430.

Meanwhile, the separate text file is created in the step 1425 in order to improve reusability of a software component. That is, by recording the text data in the separate file, the text data can be used in a function having the same file as an input parameter.

In step 1440, the ‘VideoWithText’ asset starts to be displayed using the file containing the text data as an input.

In this case, a thread or child processor is created to display a video frame in step S1445 and check the display time while displaying the text data in steps S1450 through S1470.

More specifically, first, when the video data included in the ‘VideoWithText’ asset starts to be played back, a timer starts to operate in the step S1450. The timer has information on the time when displaying the text data starts and terminates. The information about the termination time can be obtained by adding together values of the <TextStart> and <TextDuration> elements. After the time period corresponding to the <TextDuration> element for displaying the text data ends in step S1455, a time event is generated in step S1460, and it is checked whether next text data to be displayed exists in step S1465. If text data to be displayed exists, time information on the text data is extracted and delivered to the timer in step S1470, and the process returns to step S1450. Conversely, if text data to be displayed does not exist in step S1465, only a video frame is displayed.

When playback of all video data forming the ‘VideoWithText’ asset is completed, a return value is generated, and another asset is selected by the user for playback in step S1475.

An ‘AudioWithText’ asset can be displayed by using the same method as shown in FIGS. 14A and 14B.

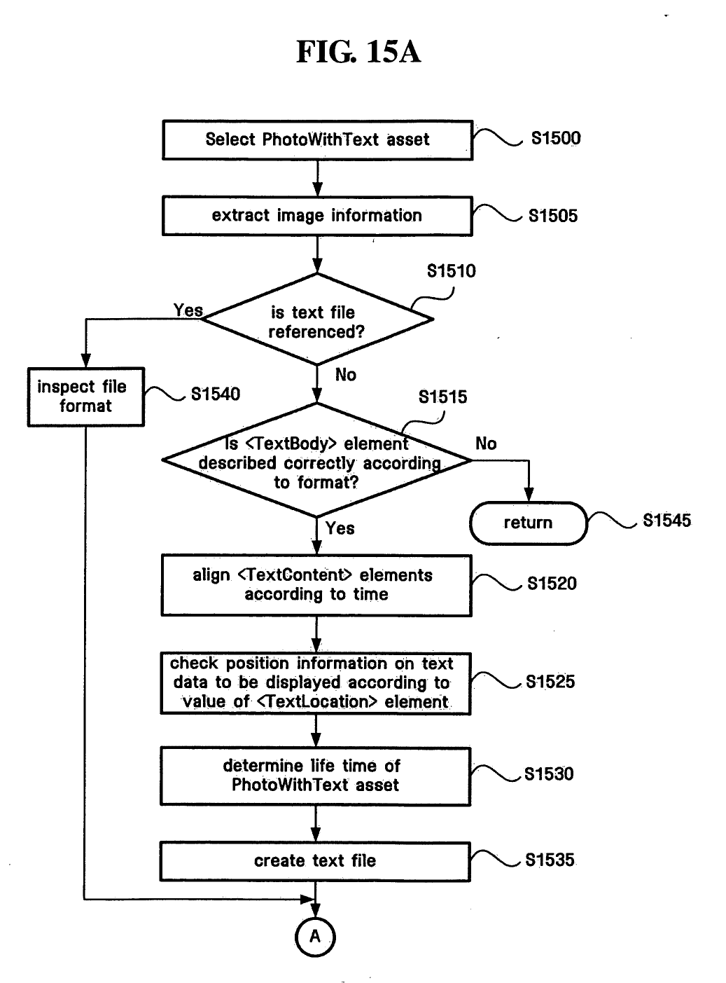

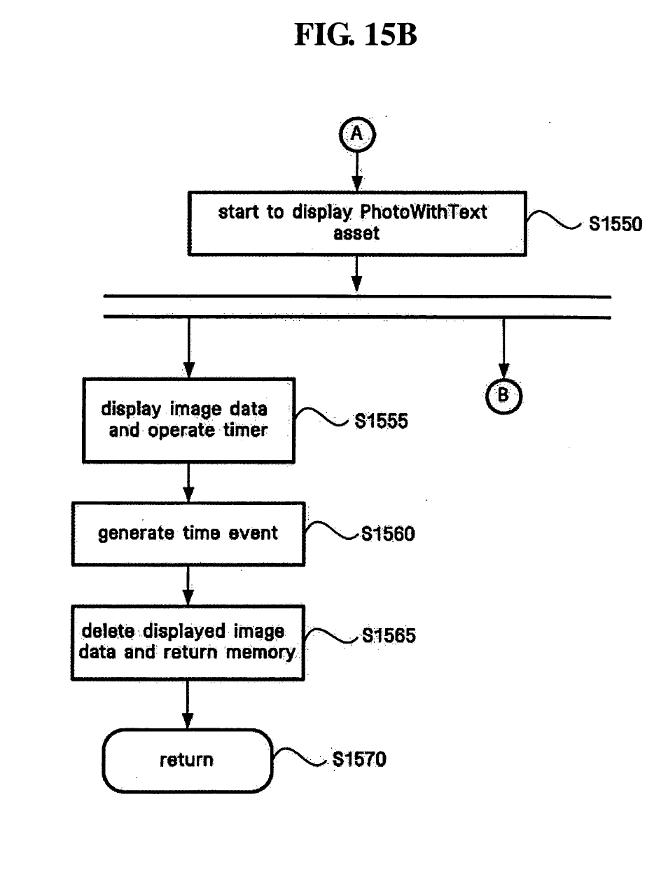

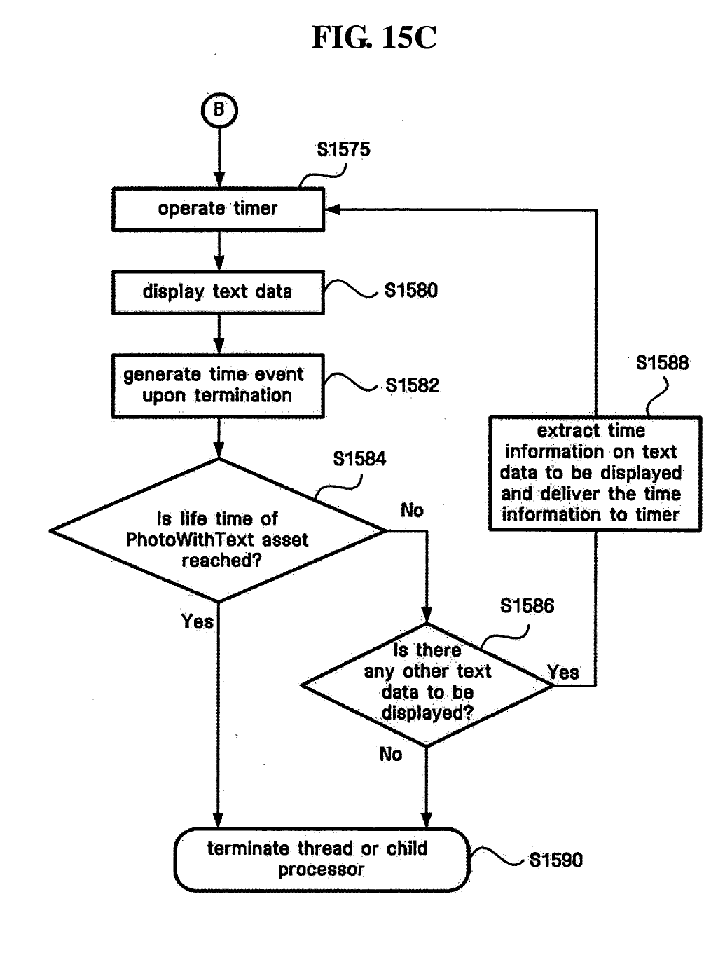

FIGS. 15A-15C are a flowchart illustrating a method for displaying a ‘PhotoWithText’ asset consistent with an embodiment of the present invention.

When a user selects the ‘PhotoWithText’ asset using software for MVP file playback in step S1500, the software extracts information on image data included in the ‘PhotoWithText’ asset in step S1505. Then, the software checks whether a text file is referenced in order to extract text data included in the ‘PhotoWithText’ asset in step S1510.

In step S1540, if the text file is referenced, i.e., a <TextRef> element is present in the asset, the software inspects the format of the text file referenced by the <TextRef> element. If the text file is well formatted, the ‘PhotoWithText’ asset starts to be displayed in step S1550. If not, an error message is generated and then delivered to the user, followed by return of a return value or termination of the appropriate program (not shown).

If the text data is directly described in the MPV file instead in step S1510, that is, a <TextBody> element is included in the asset, it is checked whether the <TextBody> element is described correctly according to the appropriate format in step S1515. If the <TextBody> element is described correctly according to the format and two or more <TextContent> elements are present, the text data to be displayed are aligned according to their temporal order in step S1520. After extracting the value of a <TextLocation> element in order to obtain position information on text data to be displayed in step S1525, a life time of the ‘PhotoWithText’ asset is determined in step S1530, and a separate text file is created in step S1535. In this case, the life time may be determined by adding together the life time of one or more text data or using the life time of the image data calculated from the image information extracted in step S1505.

Conversely, unless the <TextBody> element is described correctly according to the format in the step S1515, an error message is generated and delivered to the user, followed by a return of a return value or termination of the appropriate program in step S1545.

Meanwhile, the separate text file is created in the step 1535 in order to improve reusability of a software component. That is, since the text data is directly described in the <TextBody> element, the text data can be used in a function having the separate file as an input parameter by recording the text data in the same file.

In step 1550, the ‘PhotoWithText’ asset starts to be displayed using the file containing the text data as an input.

In this case, a thread or child processor is created to display the image data in steps S1555 through S1570 and to check the display time while displaying the text data in steps S1575 through S1590.

More specifically, first, when the image data contained in the ‘PhotoWithText’ asset starts to be displayed, a timer starts to operate in step S1555. Here, upon termination of the life time of the ‘PhotoWithText’ asset determined in step S1530, a time event is generated in step S1560. Then, the displayed image data is deleted and a memory used for displaying the ‘PhotoWithText’ asset is returned in step S1565. Thereafter, a return value is generated and another asset is selected for playback in step S1570.

Meanwhile, when the image data contained in the ‘PhotoWithText’ asset starts to be displayed, the timer may start to operate by another thread or child processor in step S1575. The timer has information on the time when displaying the text data starts and terminates. The information about the termination time can be obtained by adding together values of <TextStart> and <TextDuration> elements. After the time period corresponding to the <TextDuration> element for displaying the text data ends in step S1580, a time event is generated in step S1582 and it is checked whether the life time of the ‘PhotoWithText’ asset is reached in step S1584. If the life time of the ‘PhotoWithText’ asset is reached, the thread terminates the child processor in step S1590. On the other hand, if the life time is not yet reached in step S1584, it is checked whether the next text data to be displayed exists in step S1586. If the text data to be displayed exists, time information on the text data is extracted and delivered to the timer in step S1588, and the process returns to step S1575. Conversely, if the text data to be displayed does not exist in step S1586, the text data is not displayed and the thread or child processor is terminated in step S1590.

Multimedia data provided in the MPV format can be described in the form of an XML document. The XML document may be converted into formats of documents used for various applications based on the choice of a stylesheet on the XML document. The present invention allows the user to manage audio and video data through a browser by using a stylesheet that transforms an XML document to HTML. In addition, stylesheets that transform the XML document to Wireless Markup Language (WML) and Compact HTML (Chtml) can be used to allow the user to access multimedia data combined with text data and described in the MPV format through mobile terminals such as PDAs, cellular phones, and smart phones.

Having thus described certain exemplary embodiments of the present invention, various alterations, modifications and improvements will be apparent to those of ordinary skill in the art without departing from the spirit and scope of the present invention. Accordingly, the foregoing description and the accompanying drawings are not intended to be limiting.

The present invention provides the user with a novel type of multimedia asset that combines each of audio, photo, and video data with text data, thus allowing the user to generate and use more diverse multimedia data represented in the MPV format.

1. An apparatus for displaying multimedia data combined with text data and described according to a MusicPhotoVideo (MPV) format, the apparatus comprising:
a memory under control of a processor, the memory comprising software enabling the apparatus to:
check whether an asset selected by a user is comprised of single audio data and one or more text data,
extract information needed for displaying the audio data and the text data,
extract the audio data for playback using the extracted information, and
extract the one or more text data from the extracted information and sequentially display the extracted one or more text data using a predetermined displaying method during playback of the audio data.

2. The apparatus of claim 1, wherein the asset comprises information on a position at which the text data is displayed and a time when the text data is displayed.

3. The apparatus of claim 1, wherein the displaying method comprises displaying each text data based on display time information needed for designating the time when the text data is displayed while playing back the audio data.

4. An apparatus for displaying multimedia data combined with text data and described according to a MusicPhotoVideo (MPV) format, the apparatus comprising:
a memory under control of a processor, the memory comprising software enabling the apparatus to:
check whether an asset selected by a user is comprised of single video data and one or more text data,
extract information needed for displaying the video data and the text data,
extract the video data for playback using the extracted information, and
extract the one or more text data from the extracted information and sequentially display the extracted one or more text data using a predetermined displaying method during playback of the video data.

5. The apparatus of claim 4, wherein the asset comprises information on a position at which the text data is displayed and a time when the text data is displayed.

6. The apparatus of claim 4, wherein the displaying method comprises displaying each text data based on display time information needed for designating the time when the text data is displayed while playing back the video data.

7. An apparatus for displaying multimedia data combined with text data and described according to a MusicPhotoVideo (MPV) format, the apparatus comprising:
a memory under control of a processor, the memory comprising software enabling the apparatus to:
check whether an asset selected by a user is comprised of single image data and one or more text data,
extract information needed for displaying the image data and the text data,
extract the image data for display using the extracted information, and
extract the one or more text data from the extracted information and sequentially display the extracted one or more text data using a predetermined displaying method during the display of the image data.

8. The apparatus of claim 7, wherein the asset comprises information on a position at which the text data is displayed and a time when the text data is displayed.

9. The apparatus of claim 7, wherein the displaying method comprises displaying each text data based on display time information needed for designating the time when the text data is displayed while playing back the image data.

10. A method for displaying multimedia data combined with text data and described according to a MusicPhotoVideo (MPV) format, the method comprising:
checking whether an asset selected by a user is comprised of single audio data and one or more text data;
extracting information needed for displaying the audio data and the text data;
extracting the audio data for playback using the extracted information; and
extracting the one or more text data from the extracted information and
sequentially displaying the text data using a predetermined displaying method during playback of the audio data.

11. The method of claim 10, wherein the asset comprises information on a position at which the text data is displayed and a time when the text data is displayed.

12. The method of claim 10, wherein the displaying method comprises displaying each text data based on display time information needed for designating the time when the text data is displayed while playing back the audio data.

13. The method of claim 12, wherein the display time information includes information on a time point when displaying the text data starts, and a display duration in which the text data is played back.

14. A method for displaying multimedia data combined with text data and described according to a MusicPhotoVideo (MPV) format, the method comprising:
checking whether an asset selected by a user is comprised of single video data and one or more text data;
extracting information needed for displaying the video data and the text data; extracting the video data for playback using the extracted information; and
extracting the one or more text data from the extracted information and
sequentially displaying the text data using a predetermined displaying method during playback of the video data.

15. The method of claim 14, wherein the asset comprises information on a position at which the text data is displayed and a time when the text data is displayed.

16. The method of claim 14, wherein the displaying method comprises displaying each text data based on display time information needed for designating the time when the text data is displayed while playing back the video data.

17. The method of claim 16, wherein the display time information includes information on a time point when displaying the text data starts, and a display duration in which the text data is displayed.

18. A method for displaying multimedia data combined with text data and described according to a MusicPhotoVideo (MPV) format, the method comprising:
checking whether an asset selected by a user is comprised of single image data and one or more text data;
extracting information needed for displaying the image data and the text data;
extracting and displaying the image data using the extracted information; and
extracting the one or more text data from the extracted information and
sequentially displaying the text data using a predetermined displaying method during display of the image data.

19. The method of claim 18, wherein the asset includes information on a position at which the text data is displayed and a time when the text data is displayed.

20. The method of claim 18, wherein the displaying method comprises displaying each text data based on display time information needed for designating the time when the text data is displayed while displaying the image data.

21. The method of claim 20, wherein the display time information includes information on a time point when displaying the text data starts, and a display duration in which the text data is displayed.

22. A computer readable recording medium on which a program for displaying multimedia data described according to a MusicPhotoVideo (MPV) format is recorded, the program enabling a processor to:
check whether an asset selected by a user is comprised of single audio data and one or more text data,
extract information needed for displaying the audio data and the text data,
extract the audio data for playback using the extracted information, and
extract the one or more text data from the extracted information in order to sequentially display the text data using a predetermined displaying method during playback of the audio data.

23. The computer readable recording medium of claim 22, wherein the asset includes information on a position at which the text data is displayed and a time when the text data is displayed.

24. A computer readable recording medium on which a program for displaying multimedia data described according to a MusicPhotoVideo (MPV) format is recorded, the program enabling a processor to:
check whether an asset selected by a user is comprised of single video data and one or more text data,
extract information needed for displaying the video data and the text data,
extract the video data for playback using the extracted information, and
extract the one or more text data from the extracted information in order to sequentially display the text data using a predetermined displaying method during playback of the video data.

25. The computer readable recording medium of claim 24, wherein the asset comprises information on a position at which the text data is displayed and a time when the text data is displayed.

26. A computer readable recording medium on which a program for displaying multimedia data described according to a MusicPhotoVideo (MPV) format is recorded, the program enabling a processor to:
check whether an asset selected by a user is comprised of single image data and one or more text data,
extract information needed for displaying the image data and the text data,
extract the image data for display using the extracted information, and
extract the one or more text data from the extracted information in order to sequentially display the text data using a predetermined displaying method during display of the image data.

27. The computer readable recording medium of claim 26, wherein the asset comprises information on a position at which the text data is displayed and a time when the text data is displayed.
